(19) United States
(12) Patent Application Publication
(10) Pub. No.: US 2026/0065724 A1
(43) Pub. Date: Mar. 5, 2026

(54) VEHICLE ASSET BENCHMARKING SYSTEM

(71) Applicant: Owen John Alfie Fowler, Edgewater (AU)

(72) Inventor: Owen John Alfie Fowler, Edgewater (AU)

(21) Appl. No.: 19/106,621

(22) PCT Filed: Aug. 22, 2023
(86) PCT No.: PCT/AU2023/050800

§ 371 Date: Feb. 25, 2025

(30) Foreign Application Priority Data
Aug. 25, 2022 (AU) 2022902433

(51) Int. Cl. G07C 5/08; G07C 5/00

(52) U.S. Cl. CPC G07C 5/0816; G07C 5/008

(57) ABSTRACT

Provided is a vehicle asset benchmarking system (10) configured to obtain vehicle telemetry data from a plurality of vehicles, said vehicle asset benchmarking system (10) comprising a processing system comprising an interconnected processor, input/output interface and a memory arrangement. The processor is configured to provide a GUI to a user whereby the user is enabled to provide a vehicle species which includes telemetry data of such vehicle, collate a genus schema from the vehicle telemetry data obtained from a plurality of vehicles, compare the provided vehicle species telemetry data with the genus schema by means of a statistical benchmarking algorithm, and provide a comparison report to the user of such benchmarking, wherein the report is indicative of a condition of the vehicle species in comparison to the genus.

### TECHNICAL FIELD

This invention relates broadly to the field of machinery asset management and valuation, and more specifically to a vehicle asset benchmarking system and associated method for vehicle asset benchmarking.

### BACKGROUND ART

The following discussion of the background art is intended to facilitate an understanding of the present invention only. The discussion is not an acknowledgement or admission that any of the material referred to is or was part of the common general knowledge as at the priority date of the application.

In general, machinery asset management is a process to manage demand and guide acquisition, use and disposal of machinery assets to make the most of their service delivery potential, and manage risk and costs over their lifetime. For machinery and related equipment, such as vehicles, managing all relevant operational aspects of such machinery over its life cycle often leads to maximising resale value of such an asset.

With most vehicles, albeit privately owned vehicles or fleet vehicles, there is a desire to maximise value achieved through optimal machinery asset management. A number of different approaches have been adopted in the past for such resale value management. For example, keeping record of servicing histories and record of application provides some indication to a prospective buyer of the vehicle of an expected condition of said vehicle. Alternatively, or additionally, many prospective buyers for pre-owned vehicles inspect the vehicle prior to purchase, but such an approach can be fraught with uncertainty, particularly where unscrupulous owners may obfuscate any issues with a vehicle, including damage and/or defects, prior accidents, or the like. Many prospective purchasers may not have the mechanical or engineering knowledge to identify such issues during a pre-purchase inspection.

A number of systems have been developed to monitor use of a vehicle over certain periods. For example, U.S. Pat. No. 9,087,099B2 to Camacho et al. discloses a system and method for acquiring and maintaining, in a centralised repository, driver and vehicle information for the purpose of rendering a rating for individual drivers and vehicles in accordance with established criteria and standards. Such a driver rating generally indicates the relative desirability of the particular driver given the expected wear and tear upon a vehicle arising from driver's use of the vehicle. Such conventional systems are of particular interest to automobile rental services and rideshare services, such as Uber™, as having a rating of a driver and his/her use of a vehicle is relevant for insurance and billing purposes.

Another conventional system is described in US 2018/0108189A to General Motors LLC, which discloses a system and method of providing a telematics-based vehicle value report. This prior art system is able to poll a vehicle for sensor data wirelessly in order for a manufacturer or vehicles, such as General Motors, to compare such polled values to a manufactured baseline for that vehicle to provide a report on the polled vehicle as compared to this baseline.

However, given their intended use, such conventional solutions are predominantly focused on a driver's performance and comparing a particular vehicle to a manufacturer's baseline. In contrast, it is entirely possible for a poor driver not to influence the overall condition or quality of a vehicle, baseline values for a vehicle not being available or relevant, i.e. where an ‘old’ to ‘new’ comparison is irrelevant, or a vehicle to generate data while not specifically in use. For example, a low-quality but new vehicle can serve as a baseline for comparison which is not practically useful to benchmark used vehicles of the same type.

Accordingly, Applicant has identified a need in the art for means whereby a prospective buyer of a pre-owned vehicle or type of vehicle (or similar asset) is able to determine a qualitative and pragmatic overview of the vehicle's condition, whereby a statistical prediction can be made of future performance, value and reliability, rather than only an ‘old’ to ‘new’ baseline comparison. The current invention was conceived with this goal in mind.

### SUMMARY OF THE INVENTION

The skilled addressee is to appreciate that reference herein to a vehicle is made in a non-exclusive sense and that such reference broadly comprises reference to any suitable machinery which may be monitorable for quality purposes, as described herein. For example, a generator set, an aircraft, a power station, etc. are but some possible examples to which the broad reference to a vehicle may be applied, as relevant.

The skilled addressee is further to appreciate that reference herein to ‘the Internet’ generally refers to any suitable communications network and typically includes reference to a global system of interconnected computer networks that use the Internet protocol suite (TCP/IP) to link processing devices worldwide. Such a network includes a network of networks that may consist of private, public, academic, business, and government networks of local to global scope, linked by a broad array of electronic, wireless, and optical networking technologies.

It is also to be understood that reference herein to a ‘GUI’ refer to a Graphical User Interface, being a user interface that allows a user to interact with an electronic device, such as a terminal, processing or computing system through manipulation of graphical icons, visual indicators, text-based typed command labels and/or text navigation, including primary and/or secondary notations, as is known in the art of computer science.

In addition, reference herein to ‘GNSS’ generally refers to any suitable Global Navigation Satellite System able to provide autonomous geo-spatial positioning, including the GPS, GLONASS, Galileo, Beidou and other regional satellite systems. Furthermore, reference herein to ‘telemetry data’ include broad reference to on-board diagnostics (OBD) and related data of a vehicle, a scope of which is further defined herein.

According to a first aspect of the invention there is provided a vehicle asset benchmarking system configured to obtain vehicle telemetry data from a plurality of vehicles, said vehicle asset benchmarking system comprising a processing system comprising an interconnected processor, input/output interface and a memory arrangement, the processor configured to:
provide a GUI to a user by means of the Internet whereby the user is enabled to provide a vehicle species which includes telemetry data of such vehicle;
collate a genus schema from the vehicle telemetry data obtained from a plurality of vehicles;
compare the provided vehicle species telemetry data with the genus schema by means of a statistical benchmarking algorithm; and
provide a comparison report to the user of such benchmarking, wherein the report is indicative of a condition of the vehicle species in comparison to the genus.

In an embodiment, the vehicle asset benchmarking system is configured to obtain the vehicle telemetry data by interfacing with an original equipment manufacturer (OEM) database.

In an embodiment, the vehicle asset benchmarking system is configured to obtain the vehicle telemetry data by interfacing with a vehicle service provider database.

In an embodiment, the vehicle asset benchmarking system is configured to obtain the vehicle telemetry data by interfacing directly with in-vehicle computer systems.

In an embodiment, the vehicle telemetry data is selected from a non-exhaustive group consisting of vehicle on-board diagnostics (OBD) data, vehicle telematics, vehicle GNSS data, vehicle service history, and original equipment manufacturer (OEM) specifications.

In an embodiment, the vehicle on-board diagnostics (OBD) data is selected from a non-exhaustive group consisting of battery charging history, electric motor health, external temperature, coolant temperature, engine oil level, engine oil temperature, engine revolutions, acceleration rate, accelerometer readings, throttle position, steering angle, transmission oil level and temperature, diagnostic trouble codes (DTCs), registered faults, crash location/severity, braking performance, service due dates and history, oxygen and emission sensors, mechanical position sensors, vibration sensors, knock sensors, software update status, vehicle metadata, cybersecurity event data, GNSS positional data, and the like. The skilled addressee is to appreciate that such vehicle on-board diagnostics (OBD) data may include any monitorable aspect of a vehicle.

In an embodiment, the processor is configured to anonymise the vehicle telemetry data as the genus schema is collated.

In an embodiment, the GUI is provided by means of an application or ‘app’ which is installable on a mobile device of the user, and configured to enable said mobile device to collect the vehicle species, telemetry and/or on-board diagnostics (OBD) data from the vehicle.

Typically, the genus schema is collated by compiling a schema of comparative telemetry data from a plurality of vehicles of similar species.

In an embodiment, the statistical benchmarking algorithm defines, extracts and populates a plurality of telemetry fields across the genus, performs a statistical analysis of each field to obtain a mean or median value, and performs a per-field comparison to assign a comparative score for the vehicle telemetry data across each genus field.

In an embodiment, the statistical benchmarking algorithm includes temporal data analysis for the vehicle telemetry data and vehicle OBD data.

In an embodiment, the comparison report provides the comparative score of each compared genus field for the vehicle.

In an embodiment, the benchmarking algorithm calculates an overall condition score for the vehicle by tallying the mean or median value of the genus fields in comparison to an overall mean or median value of the vehicle OBD data.

In an embodiment, the processor is configured to perform a ‘life to expected failure’ analyses by comparing the genus schema to the vehicle telemetry data and providing a comparison therebetween as part of the report.

In an embodiment, the processor provides the comparison report via the GUI.

According to a second aspect of the invention there is provided a method for vehicle asset benchmarking comprising the steps of:
obtaining, via a processor, vehicle telemetry data from a plurality of vehicles;
providing a GUI to a user by means of the Internet whereby the user is enabled to provide a vehicle species which includes telemetry data of such vehicle;
collating, by means of a processor, a genus schema from the vehicle telemetry data obtained from a plurality of vehicles;
comparing, by means of a processor, the provided vehicle species telemetry data with the genus schema by means of a statistical benchmarking algorithm; and
providing a comparison report to the user of such benchmarking, wherein the report is indicative of a condition of the vehicle species in comparison to the genus.

In an embodiment, the step of obtaining the vehicle telemetry data comprises interfacing with an original equipment manufacturer (OEM) database.

In an embodiment, the step of obtaining the vehicle telemetry data comprises interfacing with a vehicle service provider database.

In an embodiment, the step of obtaining the vehicle telemetry data comprises interfacing directly with in-vehicle computer systems.

In an embodiment, the vehicle telemetry data is selected from a non-exhaustive group consisting of vehicle on-board diagnostics (OBD) data, vehicle telematics, vehicle GNSS data, vehicle service history, and original equipment manufacturer (OEM) specifications.

In an embodiment, the vehicle on-board diagnostics (OBD) data is selected from a non-exhaustive group consisting of battery charging history, electric motor health, external temperature, coolant temperature, engine oil level, engine oil temperature, engine revolutions, acceleration rate, accelerometer readings, throttle position, steering angle, transmission oil level and temperature, diagnostic trouble codes (DTCs), registered faults, crash location/severity, braking performance, service due dates and history, oxygen and emission sensors, mechanical position sensors, vibration sensors, knock sensors, software update status, GNSS positional data, and the like. The skilled addressee is to appreciate that such vehicle on-board diagnostics (OBD) data may include any monitored aspect of a vehicle.

In an embodiment, the method includes the step of anonymising the vehicle telemetry data as the genus schema is collated.

In an embodiment, the step of providing the GUI comprises providing an application or ‘app’ which is installable on a mobile device of the user, and configured to enable said mobile device to collect the vehicle species and telemetry data from the vehicle.

Typically, the step of collating the genus schema comprises compiling a schema of comparative telemetry data from a plurality of vehicles of similar species.

In an embodiment, the statistical benchmarking algorithm defines, extracts and populates a plurality of telemetry fields across the genus, performs a statistical analysis of each field to obtain a mean or median value, and performs a per-field comparison to assign a comparative score for the vehicle telemetry data across each genus field.

In an embodiment, the statistical benchmarking algorithm includes temporal data analysis for the vehicle telemetry data and vehicle OBD data.

In an embodiment, the step of providing the comparison report includes providing the comparative score of each compared genus field for the vehicle.

In an embodiment, the benchmarking algorithm calculates an overall condition score for the vehicle by tallying the mean or median value of the genus fields in comparison to an overall mean or median value of the vehicle OBD data.

In an embodiment, the method includes the step of performing, by means of the processor, a ‘life to expected failure’ analyses by comparing the genus schema to the vehicle telemetry data and providing a comparison therebetween as part of the report.

In an embodiment, the step of providing the report comprises providing the comparison report via the GUI.

According to a further aspect of the invention there is provided a computer programme product which, when executed by a suitable processing system, facilitates the performance of the method according to the second aspect of the invention above.

According to a further aspect of the invention there is provided a vehicle asset benchmarking system and an associated method for vehicle asset benchmarking, substantially as herein described and/or illustrated.

### BRIEF DESCRIPTION OF THE DRAWINGS

The description will be made with reference to the accompanying drawings in which:

FIG. 1 is a diagrammatic overview representation of one example of a vehicle asset benchmarking system, in accordance with an aspect of the present invention;

FIG. 2 illustrates a functional block diagram of an example processing system that can be utilised to embody or give effect to a particular embodiment of the vehicle asset benchmarking system of FIG. 1;

FIG. 3 illustrates an example network infrastructure that can be utilised to embody or give effect to a particular embodiment of a communications network whereby the processing systems of FIG. 1 can be arranged in signal communication; and

FIG. 4 is a functional block diagrammatic representation of method steps for a method for vehicle asset benchmarking, in accordance with an aspect of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Broadly, the present invention provides for a vehicle asset benchmarking system 10 which is configured to obtain vehicle telemetry data from a plurality of vehicles. As described in more detail below, such a system 10 comprises a number of constituent components, and is networked with other processing systems by means of a suitable communications network, such as the Internet, or the like, in order to fulfil their functions as part of the present invention.

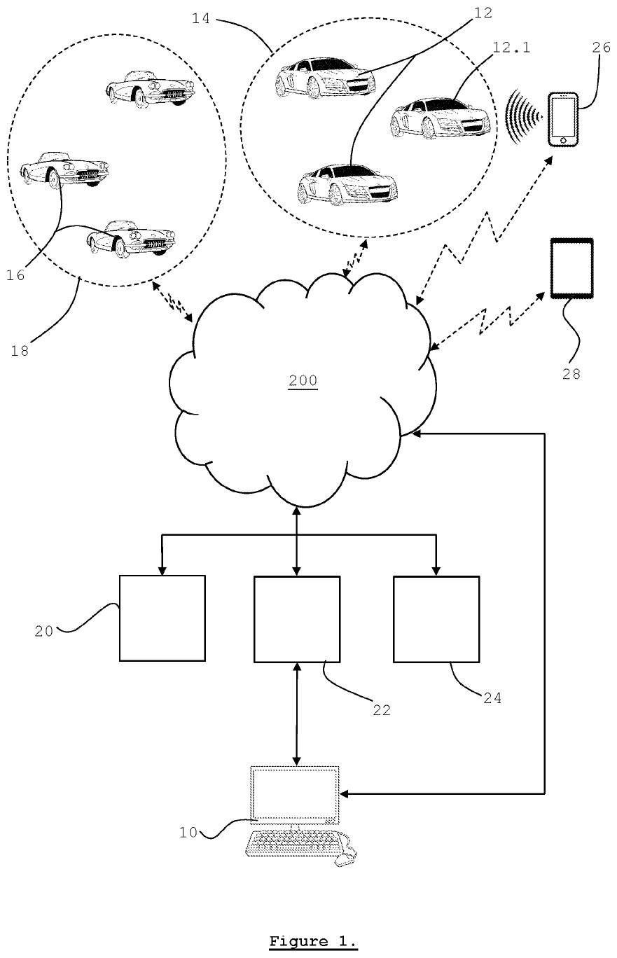

In the broad embodiment exemplified in FIG. 1, the plurality of vehicles is divided across various genera comprised of species, broadly being vehicles of the same or comparable type within a genus. In the embodiment shown, only two genera 14 and 18 are shown for illustrative purposes, with each genus comprised of a particular species 12 and 16, respectively. Accordingly, genus 14 is comprised of species 12, as indicated, with genus 18 comprised of species 16. Of course, in practice it is to be appreciated that any number of genera is possible, each comprised of any number of species.

For example, species 12 may comprise one model of vehicle, for example a Volkswagen™ Golf™ of a certain year and type, to form genus 14, and species 16 may comprise another model, such as a Mazda™ MX-5™ of a certain year and type, to form genus 18.

Broadly, the vehicle asset benchmarking system 10 comprises a processing system, as described in more detail below, which comprises an interconnected processor, input/output interface and a memory arrangement. Vehicle asset benchmarking system 10 also interfaces with various databases 20, 22 and 24, as described in more detail below, typically realised by means of a processing system.

It is to be appreciated that any reference herein to “means” specifically includes any one or more of a computer programme product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, as will be understood by the skilled addressee.

Additionally, as known in the art of computer programming, an application programming interface (API) is a set of subroutine definitions, communication protocols, and tools for building software. In general terms, it is a set of clearly defined methods of communication among various components. Means for facilitating any of the communications or interactions between the vehicle asset benchmarking system 10, databases 20, 22 and 24, and user devices 26 and 28 may be facilitated via suitable APIs within processing system 100 or network 200, as will be readily apparent to the skilled addressee.

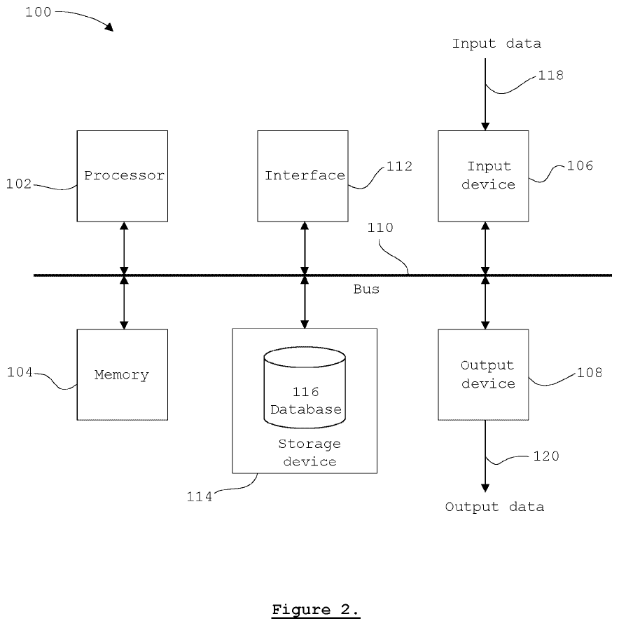

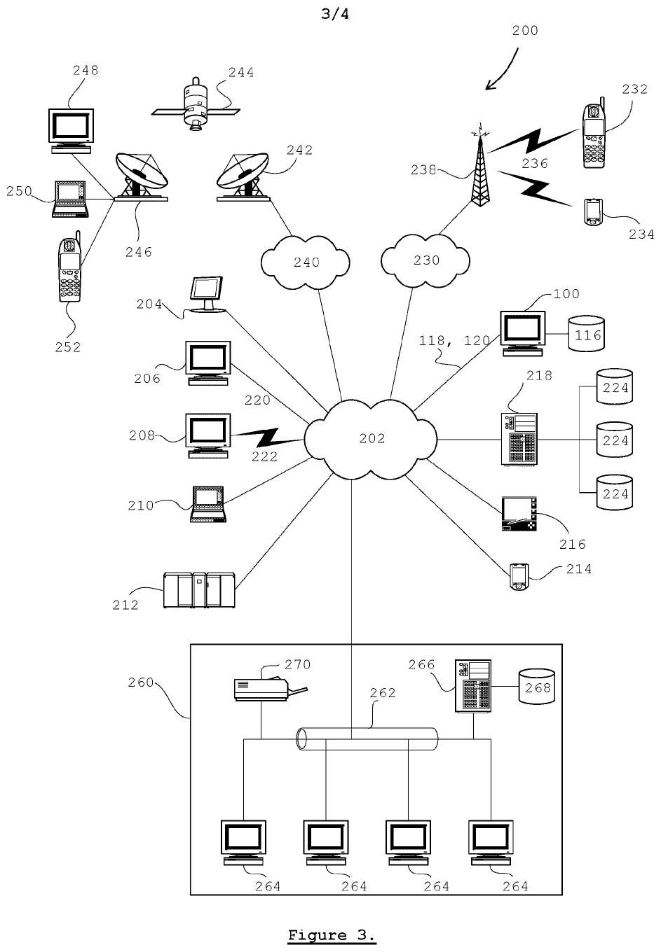

Accordingly, with reference now to FIGS. 2 and 3 of the accompanying drawings, there is shown a broad example of a processing system 100 that can be used, in different configurations as will be readily apparent to the skilled addressee, to implement the vehicle asset benchmarking system 10, as described in more detail below, as well as databases 20, 22 and 24, as well as user devices 26 and 28. Similarly, FIG. 2 shows a broad example of a networked communications system 200 whereby the respective processing and computer systems can be arranged in signal communication.

By way of background, in a general networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or Satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated with other devices, for example a local data storage device such as a hard disk drive or solid-state drive.

An information source can include a server, or any type of terminal, that may be associated with one or more storage devices that are able to store information or data, for example in one or more databases residing on a storage device. The exchange of information (i.e. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The Internet, which often serves as an enabling part of communications network 200, is the large-scale interconnection of public and private networks. The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network. The network itself may take a variety of forms. For example, it may be a computer network, telecommunications network, data communications network, Local Area Network (LAN), Wide Area Network (WAN), wireless network, Internetwork, Intranetwork, the Internet, etc.

In light of this general background, the processing system 100 of FIG. 2 generally includes at least one processor 102, or processing unit or plurality of processors, memory 104, at least one input device 106 and at least one output device 108, coupled together via a bus or group of buses 110. Typically, the processor 102 comprises any suitable processor or microcontroller configured to receive input, perform logical and arithmetical operations on a suitable instruction set, and provide output, as well as transitory and/or non-transitory electronic storage, such as memory 104 and storage device 114, or the like.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing System 100.

Input device 106 receives input data 118 and can include, for example, a keyboard, a pointer device such as a pen-like device or a mouse, audio receiving device for voice-controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network, or a dedicated global navigation satellite system (GNNS) sensor, as is known in the art, or the like. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a touchscreen, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

As described, the processing system 100 is generally part of a networked communications system 200, as shown in FIG. 3. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Servers 218 and 266 and one or more databases 224 provide an example of databases 20, 22 and 24, for example.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200. Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

In one embodiment, networked communications between processing systems may be secured via a blockchain. As will be understood by the skilled addressee, a blockchain is a distributed electronic ledger which is a publicly or privately accessible database that maintains a continuously-growing list of electronic data records hardened against tampering and revision. A blockchain typically consists data structure blocks with each block holding batches of individual transactions. Each block contains a timestamp and information linking it to a previous block, typically via a hash of the prior block. The linked blocks form a chain, with each additional block reinforcing those before it. A blockchain is peer-to-peer over an open or private communications network, such as the Internet or private network, where every user on the network is allowed to connect to the blockchain ledger, send new transactions to it, verify transactions, and create new blocks or immutable records.

Accordingly, in the manner described above, the vehicle asset benchmarking system 10, the databases 20, 22 and 24, and user devices 26 and 28 are generally realisable via suitable versions of the processing system 100, as described above, and networked together to perform the functions and provide the features broadly described herein, in accordance with the network means of FIG. 3.

Specifically, the vehicle asset benchmarking system 10 of the present invention is configured to obtain vehicle telemetry data from a plurality of vehicles, as indicated by reference numerals 12 and 16. In one embodiment, the vehicle asset benchmarking system 10 is configured to obtain the vehicle telemetry data by interfacing with an original equipment manufacturer (OEM) database 20. In another embodiment, the vehicle asset benchmarking system 10 is configured to obtain the vehicle telemetry data by interfacing with a vehicle service provider database 22. In a yet further embodiment, the vehicle asset benchmarking system 10 is configured to obtain the vehicle telemetry data by interfacing with a third-party database 24, or the like. In this manner, any suitable source of telemetry data, either internal to the vehicle or external to the vehicle, can be used to gather information pertaining directly to the state of the vehicle or provides information pertaining to external variables that may impact the state of the vehicle.

The skilled addressee is to appreciate that, in a preferred embodiment, the vehicle asset benchmarking system 10 may also obtain vehicle telemetry data directly from in-vehicle computer systems. For example, vehicle telemetry data may be harvested directly from each vehicle arranged in communication with the Internet, via a smartphone with a suitable app linked to such vehicle, or the like.

Such vehicle telemetry data may take a variety of forms, including on-board diagnostics (OBD) data, vehicle telematics, vehicle GNSS data, vehicle service history, and original equipment manufacturer (OEM) specifications. As above, different types of vehicle telemetry data may be obtained from different sources, for example OEM specifications may be obtained from the OEM database 20, vehicle service history from the vehicle service provider database 22, on-board diagnostics (OBD) data from third-party database 24, and the like.

The skilled addressee is further to appreciate that the vehicle on-board diagnostics (OBD) data may include any monitored aspect of a vehicle, such as a battery charging history, electric motor health, external temperature, coolant temperature, engine oil level, engine oil temperature, engine revolutions, acceleration rate, accelerometer readings, throttle position, steering angle, transmission oil level and temperature, diagnostic trouble codes (DTCs), registered faults, crash location/severity, braking performance, service due dates and history, oxygen and emission sensors, mechanical position sensors, vibration sensors, knock sensors, software status, GNSS positional data, and the like. For example, GNSS positional data can be used to determine where a vehicle was predominantly used, such as on a mine site, for city driving, driving long distances, etc.

Additionally, with more modern vehicles, a software status may be included as part of the (OBD) data and comprised of aspects such as vehicle metadata, cybersecurity event data, software update status, etc. For example, in one embodiment, cybersecurity benchmarking may be performed for the purposes of sale of the vehicle. Such cybersecurity OBD data may comprise vehicle metadata (data upload/download rates), and Indicators of Compromise (IOC). In this manner, software features and aspects of connected/autonomous vehicles may be monitored and benchmarked, e.g. analysis of metadata/IOCs may indicate that a vehicle for sale has been hacked and a buyer is able to see this as it pertains to their safety (real-world instances of malicious parties hacking vehicle and disabling brakes/changing vehicle speed) and/or privacy (real-world instances whereby privacy is violated through the use of in-vehicle microphones/external cameras etc.)

Similarly, benchmarking of such vehicle cybersecurity OBD data may be used for the purpose of monitoring vehicle condition throughout the life of the vehicle. Such periodic monitoring may facilitate early detection of potential issues and may facilitate with maintenance and upkeep to extend a service life of the vehicle.

Such vehicle on-board diagnostics (OBD) data may be specific to vehicle genus, for example, where certain vehicle species have comparable vehicle on-board diagnostics (OBD) data which is not directly comparable with other species across genera. For example, an electric vehicle may include specific details as part of vehicle on-board diagnostics (OBD) data which is not comparable with other genera.

The vehicle asset benchmarking system 10, as a processing system, generally comprises a suitable processor which is configured to provide a GUI to a user, typically via the Internet, whereby the user is enabled to provide a vehicle species which includes on-board diagnostics (OBD) data of such vehicle. In one embodiment, the GUI is provided by means of an application or ‘app’ which is installable on a mobile device of the user, and configured to enable said mobile device to collect the vehicle species and on-board diagnostics (OBD) data from the vehicle. For example, a user (as presented by mobile phone 26) may collect the vehicle species and on-board diagnostics (OBD) data from vehicle 12.1 directly, with such collected information sent to vehicle asset benchmarking system 10. Alternatively, or additionally, the GUI may be provided as a website, or the like.

Vehicle asset benchmarking system 10 is then configured to collate a genus schema from the vehicle telemetry data obtained from a plurality of vehicles, where the genus is comprised of the same species as vehicle 12.1. As described above, such vehicle telemetry data may take a variety of forms as relevant to that particular species and may be obtained from a variety of sources. In one embodiment, the processor of system 10 may be configured to anonymise the vehicle telemetry data as the genus schema is collated. Typically, the genus schema is collated by compiling a schema of comparative telemetry and OBD data from a plurality of vehicles of similar species.

Vehicle asset benchmarking system 10 broadly compares the provided vehicle species OBD data with the collated genus schema by means of a statistical benchmarking algorithm. In one embodiment, the statistical benchmarking algorithm defines, extracts and populates a plurality of OBD fields across the genus, performs a statistical analysis of each field to obtain, for example, a mean or median value, and performs a per-field comparison to assign a comparative score for the vehicle OBD data across each genus field. In one embodiment, the statistical benchmarking algorithm also includes temporal data analysis for the vehicle telemetry data and vehicle OBD data, i.e. specific vehicle telemetry data is to be interpreted over a predetermined period of time. It is to be appreciated that other benchmarking options are apposite, e.g. high and low values, outliers, data spread, etc.

In one embodiment, the benchmarking algorithm calculates an overall condition score for the vehicle by tallying, i.e. accounting for, a mean, median or other value of the genus fields in comparison to an overall mean, median or other value of vehicle data, such as the vehicle OBD data. It is to be appreciated that the benchmarking algorithm may calculate a similar condition score for each genus field for the vehicle, whereby a more granular indication of each field for that particular vehicle is provided, e.g. a comparison for each subsystem of the vehicle, such as power unit, exhaust/emissions system, fuel system, software systems, etc. In such a manner, various types of statistically significant comparisons are calculable, as required.

In a further embodiment, the processor may also be configured to perform a ‘life to expected failure’ analyses by comparing the genus schema to the vehicle OBD data and providing a comparison therebetween as part of a report. For example, such a ‘life to expected failure’ may be performed to allow vehicle fleet managers to determine which vehicles to include as part of a fleet and allow budgeting for key component replacement/failure based on real world data gathered from similar genus vehicles of the same make/model. In such a manner, system 10 find particular application for asset preventative maintenance.

Lastly, vehicle asset benchmarking system 10 generally provides a comparison report to the user, wherein the report is indicative of a condition of the vehicle species in comparison to the genus across the schema fields. In one embodiment, the comparison report provides the comparative score of each compared genus field for the vehicle. Typically, the processor provides the comparison report via the GUI, but variations hereon are possible and expected. For example, the report may be provided to tablet 28, which may be that of a third-party, such as a car dealership, a prospective buyer of vehicle 12.1, or the like. Such a condition report may also form part of a vehicle service history, showing a benchmarked condition at various stages of the vehicle's operational life, e.g. at each scheduled service, etc.

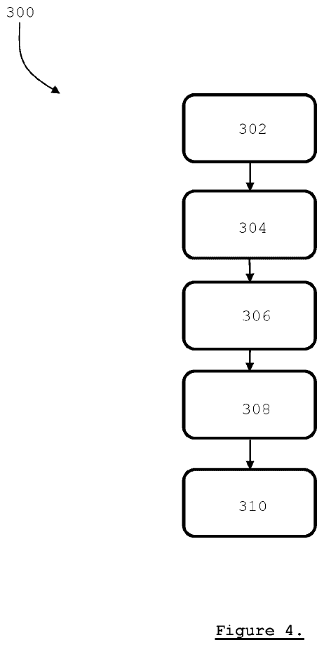

With reference to FIG. 4, the present invention also includes an associated method 300 for vehicle asset benchmarking. Such a method 300 broadly comprises the steps of obtaining 302, via a processor, vehicle telemetry data from a plurality of vehicles, providing 304 a GUI to the user by means of the Internet whereby the user is enabled to provide a vehicle species which includes on-board diagnostics (OBD) data of such vehicle, and collating 306, by means of a processor, a genus schema from the vehicle telemetry data obtained from a plurality of vehicles. Method 300 also includes the steps of comparing 308, by means of a processor, the provided vehicle species OBD data with the genus schema by means of a statistical benchmarking algorithm, and providing 310 a comparison report to the user of such benchmarking, wherein the report is indicative of a condition of the vehicle species in comparison to the genus.

The telemetry-based analysis and benchmarking of the present invention may be used to provide a ‘certified pre-owned’ classification for pre-owned vehicles, as well as third-party warranty products, and may also be used to generate a price estimation/comparison report (through combination of this process with pricing information available for the same/similar vehicles contained within the comparative group, or currently for sale in a market).

For example, the technology can be used by second hand car dealers to negotiate a fair price on a trade-in, and can also be used to ensure quality of inventory. This can be offered by dealerships to potential customers to ensure buyer confidence in a pre-owned vehicle.

In addition to such benchmarking/comparative analyses, the system 10 may also include a ‘life to expected failure’ analyses, whereby a vehicle is analysed in the context of telemetry-based data (data that may be gathered over the duration of release of a specific model) on anticipated failure rates/expected life of major components for that specific make/model. The resulting analysis is useable to predict a vehicle's remaining time/mileage to failure for components or systems based on the average of that make/model, i.e. species, which in turn is based on telemetry data gathered from that population of vehicles. Reporting may be on prominent systems/components, or components that have proved troublesome for that specific make/model.

It is to be appreciated that the system 10 can collate a temporal genus schema, where the benchmarking algorithm is configured to calculate an overall condition score over a period of time, i.e. a temporal aspect included as part of any statistical analysis of OBD and related vehicle information. In the manner described, the present invention is able to perform an ‘apples-to-apples’ comparison of a vehicle, i.e. condition of the vehicle species in comparison to the genus, rather than an ‘old’ to ‘new’ comparison which is not relevant when purchasing a used vehicle or related asset. For example, if a certain genus of vehicle is known to be problematic and require ongoing maintenance and upkeep, comparing a used species of said genus to the overall genus when new is not helpful, whereas comparing a species to a statistically analysed genus, all of which have been ‘used’ over time, will provide much more insight into a condition of the species.

Applicant believes it particularly advantageous that the present invention provides for a system and method whereby a vehicle, as an asset, is comparable with similar vehicles as a genus, with such comparison useable to provide an accurate indication of a condition of the vehicle. Specifically, vehicle telemetry data is comparable across a genus, making the comparison an ‘apples-to-apples’ comparison as applicable to a specific species of vehicle. Such benchmarking may facilitate valuation of a vehicle at any given time, as well as enable ongoing condition monitoring for maintenance purposes.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Accordingly, one example may exemplify certain aspects of the invention, whilst other aspects are exemplified in a different example.

Any method steps, processes, and operations described herein are not to be construed as necessarily requiring their performance in the particular order discussed or illustrated, unless specifically identified as an order of performance. It is also to be understood that additional or alternative steps may be employed.

1. A vehicle asset benchmarking system comprising:
a plurality of vehicles configured to provide vehicle telemetry data;
at least one mobile device of a user, said mobile device configured with an application or ‘app’ to provide a vehicle species including particular telemetry data of such vehicle species; and
a processing system comprising an interconnected processor, input/output interface and a memory arrangement, the processor configured to:
provide a GUI to user mobile device by means of the Internet;
upon receipt, from the GUI, of the vehicle species including particular telemetry data, collate a genus schema from vehicle telemetry data obtained from the plurality of vehicles, said genus schema collated by compiling a schema of comparative telemetry data from the plurality of vehicles of similar species;
compare the telemetry data of the provided vehicle species with the genus schema by means of a statistical benchmarking algorithm configured to:
i. calculate an overall condition score for the provided vehicle species by corresponding the mean or median value of corresponding genus fields in the genus schema to a mean or median value of the provided vehicle telemetry data; and
ii. analyse temporal data of the collated genus vehicle telemetry data to perform a ‘life to expected failure’ analysis by comparing such temporal data to the provided vehicle telemetry data; and
provide a comparison report to the user of such overall condition score and ‘life to expected failure’ analysis, wherein the report is indicative of a condition of the vehicle species in comparison to the genus.

2. The vehicle asset benchmarking system of claim 1, wherein the processing system is configured to obtain the vehicle telemetry data by interfacing with an original equipment manufacturer (OEM) database.

3. The vehicle asset benchmarking system of claim 1, wherein the processing system is configured to obtain the vehicle telemetry data by interfacing with a vehicle service provider database.

4. The vehicle asset benchmarking system of claim 1, wherein the processing system is configured to obtain the vehicle telemetry data by interfacing directly with in-vehicle computer systems.

5. The vehicle asset benchmarking system of claim 1, wherein the vehicle telemetry data is selected from a non-exhaustive group consisting of vehicle on-board diagnostics (OBD) data, vehicle telematics, vehicle GNSS data, vehicle service history, and original equipment manufacturer (OEM) specifications.

6. The vehicle asset benchmarking system of claim 1, wherein the vehicle on-board diagnostics (OBD) data is selected from a non-exhaustive group consisting of battery charging history, electric motor health, external temperature, coolant temperature, engine oil level, engine oil temperature, engine revolutions, acceleration rate, accelerometer readings, throttle position, steering angle, transmission oil level and temperature, diagnostic trouble codes (DTCs), registered faults, crash location/severity, braking performance, service due dates and history, oxygen and emission sensors, mechanical position sensors, vibration sensors, knock sensors, software update status, vehicle metadata, cybersecurity event data, and the like.

7. The vehicle asset benchmarking system of claim 1, wherein the processor is configured to anonymise the vehicle telemetry data as the genus schema is collated.

8. The vehicle asset benchmarking system of claim 1, wherein the mobile device is configured collect the vehicle species and particular telemetry data of the vehicle.

9. The vehicle asset benchmarking system of claim 5, wherein the mobile device is configured to collect on-board diagnostics (OBD) data from the vehicle.

10. The vehicle asset benchmarking system of claim 1, wherein the statistical benchmarking algorithm defines, extracts and populates a plurality of OBD fields across the genus, performs a statistical analysis of each field to obtain a mean or median value, and performs a per-field comparison to assign a comparative score for the vehicle OBD data across each genus field.

11. The vehicle asset benchmarking system of claim 1, wherein the comparison report provides the comparative score of each compared genus field for the vehicle.

12. The vehicle asset benchmarking system of claim 1, wherein the processor provides the comparison report via the GUI.
